(19) United States
(12) Patent Application Publication
(10) Pub. No.: US 2010/0194861 A1
(43) Pub. Date: Aug. 5, 2010

(54) Advance in Transmission and Display of Multi-Dimensional Images for Digital Monitors and Television Receivers using a virtual lens

(76) Inventor: Reuben Hoppenstein, New Rochelle, NY (US)

Correspondence Address: KEITH D. NOWAK, CARTER LEDYARD & MILBURN LLP, 2 WALL STREET, NEW YORK, NY, 10005, US

(21) Appl. No.: 12/362,523

(22) Filed: Jan. 30, 2009

(51) Int. Cl. H04N 13/02

(52) U.S. Cl. 348/48; 348/E13.074

(57) ABSTRACT

The present invention provides an advance in multi-dimensional displays for digital monitors and televisions. In general, the present invention provides image capture devices arranged at different angles about a target image, or in a straight line, to capture images at pre-designated angles. Each captured image is combined into a composite image using hardware such as a computer. The composite image and a virtual lens are then transmitted together to a display means to be viewed having stereoscopic characteristics.

### PRIORITY AND RELATED APPLICATION

N/a.

### FIELD OF THE INVENTION

This invention generally relates to a novel virtual lens for transmitting stereoscopic images and specifically concerns novel techniques and apparatus for viewing such images for use with flat screen televisions, computer displays, fluoroscopes and other imaging electronic recording and imaging devices, either analog or digital, providing an illusion of depth to the viewer.

### BACKGROUND OF THE INVENTION

Many of the modern day techniques use lenticulated images to create stereoscopic images. These techniques are limited in that they require the use of a lenticular viewing lens to visualize the stereoscopic image. In general, stereoscopic photographs of an object can be made by exposing a photographic film record through a lenticular screen with attendant relative movement between the camera lens, the object, and/or the film to provide a lenticulated or strip-like base image, each strip-like image being representative of a different viewing angle of the object being photographed. When the resulting exposed base film image is viewed through a lenticular screen having suitable optical characteristics, the picture seen will appear to have depth and will generally have stereoscopic characteristics, regardless of the viewing angle.

In addition to depth, stereoscopic images can be used to convey a fourth dimension, time, as a sequence of images (so-called “Four-Dimensional” (4D) images). For example, a sequence of ten exposures, each separated by a fraction of a second, can be combined to produce a short movie. If during exposure the film is moved on its vertical or horizontal axis so that each of the ten exposures captures a different view of the object, person or scene, a time sequence of events occurring can be viewed from a single formatted, complex image as described in U.S. Pat. No. 3,783,282, (the '282 patent) issued to Reuben Hoppenstein on Jan. 1, 1974 and entitled “Stereoscopic Radiography Techniques and Apparatus,” hereby incorporated by reference as if fully set forth herein. A method and apparatus for stereographic radiography are described in this patent, wherein a conventional x-ray source is used as a source of radiant energy.

In U.S. Pat. No. 5,049,987 (the '987 patent) and U.K. Patent No. 9722146.9, also issued to Reuben Hoppenstein and entitled “Method and Apparatus for Creating Three-Dimensional Television or Other Multi-Dimensional Images,” a method of recording a scene and its transmission was described wherein the viewing of a combined or complex image is achieved by using a lenticular lens in front of a CRT or LCD screen. In the '987 Patent, hereby incorporated by reference as if fully set forth herein, the techniques of the '282 patent were extended to apply to the fields of fluoroscopy, Computerized Axial Tomographs, Magnetic Resonance Imaging, Television, Movies and the three dimensional display of other types of visual images. In these patents, it was shown how a grid imprinted on a first surface of a transparent film, which separated the multiplexed image on a second surface, acts as a lenticular lens, creating a 3D image which can be visualized without optical devices.

U.S. Publication 2002/0101658 filed Jan. 29, 2001, now abandoned, and Japanese Patent No. 4,111,832 issued on Apr. 18, 2008, both to Reuben Hoppenstein, entitled “Electronic Virtual Lens For Observing 3-D Or 4-D Images,” are also incorporated by reference herein. The Japanese patent describes a system for viewing 3-D or 4-D images on displays using a virtual viewing lens apparatus, wherein the apparatus comprises an electromechanical screen with a plurality of thin metal shutters.

The techniques described in the '282 patent, the '987 U.S. patents and the '832 Japanese patent is limited by the required use of a lenticular viewing screen that must be properly aligned with respect to the subject image in order to appreciate the stereoscopic view. Moreover, the use of this screen is time consuming, requires micrometers for adjustment and is generally more expensive. Further limitations of the Japanese Patent Number 4,111,832 include the need for different sized electromechanical devices (grids) for differing sized screens.

To address the shortcomings of the prior art, it is an aspect of the present invention to provide an advance in virtual lens transmission for digital monitors and televisions. The present invention provides the transmission of the virtual lens in a simple, economical and universally acceptable method.

It is an aspect of the present invention to create a virtual grid digitally. It is also an aspect of the present invention to create a digital virtual grid that is accurately aligned with the multiplexed image. Another aspect of the present invention is to create a digital virtual grid image using image capture devices arranged at different angles around a target image. Yet another aspect of the present invention is to be able to view a virtual grid, digitally without the need for a lenticular device by a display or screen for viewing. An aspect of the present invention is also to forgo the need for special accommodations to view three-dimensional image on screens of different sizes. It is also an aspect of the present invention to obviate the need for constant re-alignment to avoid misaligned images screens on the receiver.

It is a further aspect of the present invention to expand on the teachings of U.S. Pat. No. 6,061,424, U.K. Patent No. 9722146.9 and Japanese Patent No. 4,111,832 issued to Hoppenstein, et al. on May 9, 2000, Mar. 8, 2000 and Apr. 18, 2008 respectively, the teachings of which are incorporated herein by reference. As stated above, Japanese Patent No. 4,111,832 has the same specification as U.S. publication US2002/0101658.

### BRIEF SUMMARY OF THE INVENTION

The present invention provides an advance in virtual lens transmission for digital monitors and televisions. The present invention provides image capture devices arranged at different angles about a target image to capture images at pre-designated angles or using multiple capturing devices, side by side, mounted on a rigid bar in a straight line. Each captured image is combined into a composite image or multiplexed image using hardware such as a computer. The composite image is then transmitted to a display to be viewed having stereoscopic characteristics.

### BRIEF DESCRIPTION OF THE DRAWING

FIG. 1 is a prior art schematic illustration of a prior art optical technique for obtaining a film record containing parallax and providing a visual depth effect.

FIG. 2 is a prior art schematic illustration of a film containing a plurality of discrete images providing depth information, and an overlying lenticular screen so as to enable observation of the film record from virtually any angle, as above discussed.

FIG. 3A is a schematic diagram illustrating a first embodiment of the present invention.

FIG. 3B is a schematic diagram illustrating an alternate embodiment of the present invention.

### DETAILED DESCRIPTION OF THE INVENTION

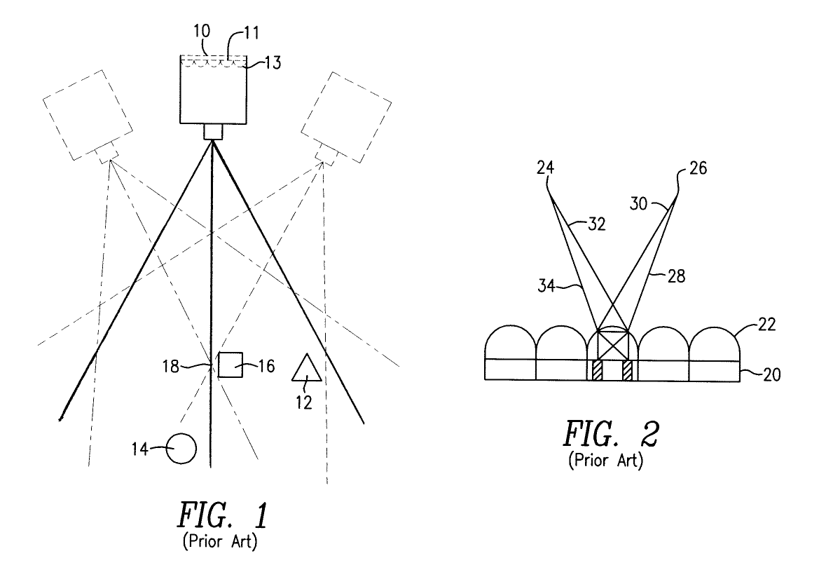

Typical prior art cameras for obtaining stereographic photographs are well known and are schematically indicated in prior art FIG. 1. They generally comprise a standard commercial camera 10 mounted on a suitable non-illustrated structure for traversing a path about one or more subject images 12, 14 and 16, film 11, and an overlying lenticular screen 13. As shown in FIG. 1, camera 10 is capable of being moved between dotted-line positions along an arc whose radii intersect at point 18, the central point of any particular picture to be taken. The different relative positions of the camera while photographing the object, or the difference in point of view, i.e., parallax, of the camera as it traverses its arc is illustrated by the rays extending, from each of the cameras. The relative rays are designated by dotted lines with respect to the left position of the camera, by solid lines with respect to the central position of the camera, and by dash lines with respect to the right position of the camera. It should therefore be noted that with this arrangement, camera 10 will view the objects 12, 14 and 16 from different points of view as the camera traverses its arcuate path.

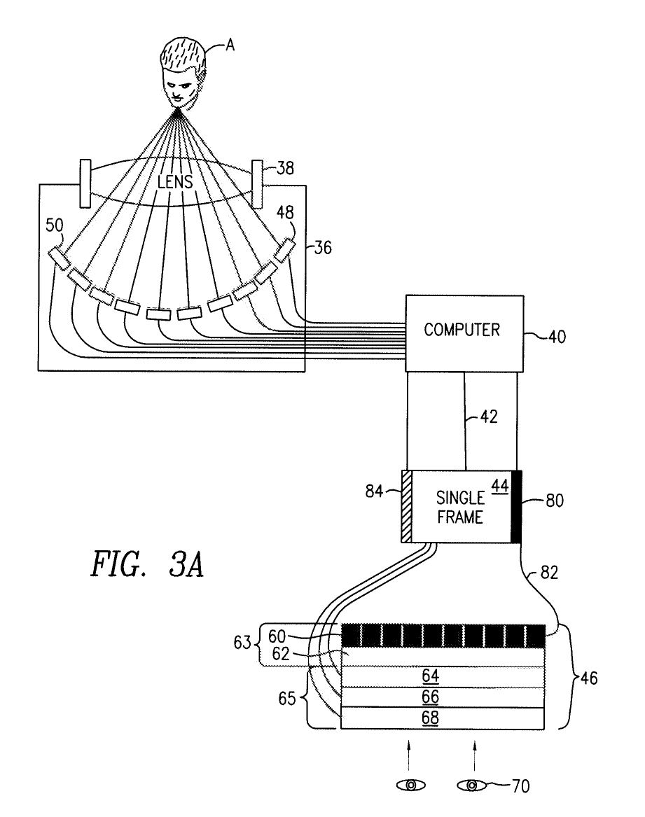

Lenticular screen 13, positioned between the camera lens and film 11, must be sequentially moved along with movement of camera 10 between the two end points of the arcuate path. By virtue of the refractive and focusing characteristics of the lenticle elements of lenticular screen 13, light received by the camera lens and passing to the screen 13 will be focused onto a given vertical line of film 11 behind each lenticle and, as the screen moves, this vertical line also moves so as to produce the lenticulated image on film 11. The developed film is illustrated at 20 in prior art FIG. 2. What will be stored, then, on the camera film, is a plurality of lenticulated images or strips of the objects 12, 14 and 16, each viewed from a different angle and thus containing what can be termed parallax. In the prior art, a stereoscopic view of the image could only be seen through a superimposed plurality of lenticles forming a viewing screen 22, similar to screen 13.

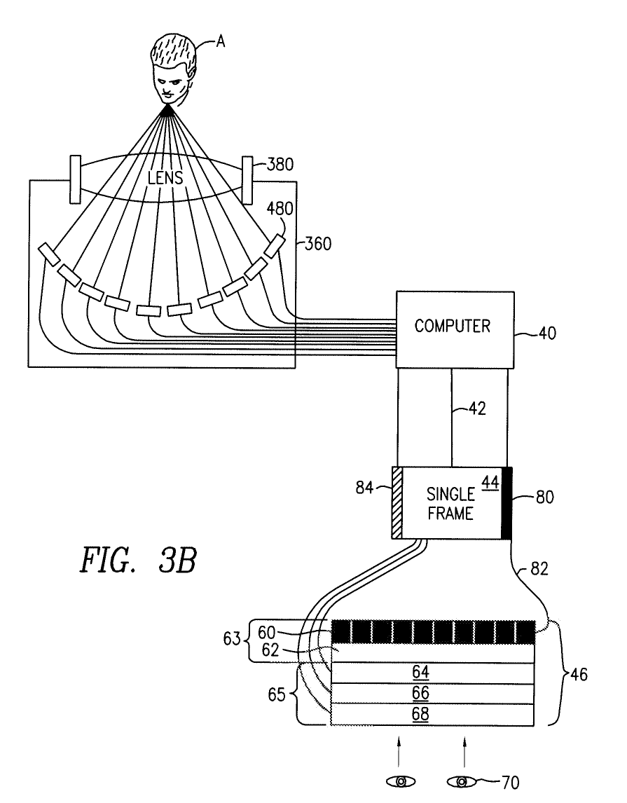

The present invention eliminates the undesirable lenticular viewing screen as described above. In general, as shown in FIG. 3A, the present invention provides image capture devices 48 arranged at different angles about a target image A to capture images at pre-designated angles. Each captured image is combined into a composite image or multiplexed image 42 using hardware 40 such as a computer. The composite image 42 is then transmitted to a display means 46. Viewer 70 views the stereoscopic image on the display means 46 without a lenticular device.

A first embodiment of the instant invention illustrated in FIG. 3A shows a single camera 36 having a single lens 38 and a plurality of image capture devices 48 each including a separate grid or lenticular means, such as a lenticular lens 50, or both, in front of, and in contact with, the image capture devices 48. Ten image capture devices 48 are oriented in an arc-shape and capture ten separate images of target A through lenticular means 50. In this first embodiment, a virtual grid is created using the lenticular means 50 disposed with the image capture devices 48. It should be noted that the capturing devices can also be created by mounting “N” digital cameras, side by side, in a straight line or even using no lenticular lens or virtual grid as will be described below.

Each captured image only shows a slight variation in observation of target A wherein each device 48 is only capturing a predetermined fractional sub-zone of the target A through lenticular means 50. The number of images captured of the target A and thus the predetermined fractional sub-zone of the target A depends on the number of image capture devices employed. Here, each captured image only reflects a predetermined one-tenth sub-zone of the target A as only ten image capture devices 48 are used.

The grid and multiplexed image can be created with “N” views, where “N” is the number of views. It is to be understood herein that the number of views of the target image could be more than two or more views. The limiting factor is the size of the megapixel recording device and that of the monitor. The greater the number of angles recorded, the greater the 3D effect and viewing angle is wider, allowing several observers to see the same image from different angles. This is not possible when only two views are recorded. In such a 3D format, usually only one person can perceive the 3D image. For instance, if only two views are to be combined, only two cameras are used. To combine three views, three cameras are oriented and used. The number of images can vary according to the requirements of the study. While, at least two differing views are necessary for a three dimensional effect, one preferred range of views is between two and ten.

The resultant electronic signals of all ten sub-zones captured by the image capture devices 48 with lenticular means 50 are transmitted to device 40 to be integrated. Device 40 integrates or multiplexes the signals from the image capture devices 48 into a composite image or multiplexed image 42. Device 40 may be a computer, processor or other hardware and in some instances may also include software. Device 40 also receives a virtual grid image 80 taken by the image capture devices 48 with lenticular means 50. A grid, as used herein, is in general the type of grid described in U.S. Pat. No. 5,049,987 only generated as a virtual grid with the substantial advantages described below. This virtual grid image 80 is transmitted on a separate narrow band frequency channel 82 to display means 46 discussed in detail below.

Using device 40, the plurality of captured images can also be stored on some suitable storage medium, in immediately adjacent positions to create the composite image 42. The stored multiplexed image may then be viewed as a three-dimensional image on a display means 46. The multiplexed image of the present invention has the same effect as the prior art, in that the viewer simultaneously sees separate images of the same picture differing in point of view by the respective eyes of a viewer 70, giving rise to a three-dimensional illusion. Similarly, if during the creation of multiple images, movement occurs, such as the beating of a heart in a chest x-ray, then on the finished picture, a short time sequence will result.

It is not important for purposes of the instant invention what particular technique or technology would be used to capture and integrate and/or store the various images. Image capture devices 48 can include electronic image capture devices, such as but not limited to digital cameras, photo conductors, or other suitable devices, capable of converting visual images into electronic signals. For example, the image could be captured by photographic, electronic or radiographic means, and any reference to the term camera hereinafter is understood to encompass any and all known means of image capture. In addition, it should be understood that device 40 could include any well-known electronic storage medium, along with standard devices for assembling the separate strip images into a composite image 42. Storage of the image is preferably done on digital media such as digital memory but other techniques may be used as well.

The resultant electronic composite image or multiplexed image 42 is then transmitted via standard transmission equipment to a single frame 44 and finally to the display or display means 46. The virtual grid 80 is also transmitted to display means 46 via the single frame 44, but the virtual grid 80 is transmitted on the edge of frame 44. For example, if the frame 44 is 8×10 inches the multiplexed image 42 will occupy 8×9 inches of the frame leaving 8×1 inches for the virtual grid image. The multiplexed image and the virtual grid are side by side on the frame 44 and do not over lap. As the virtual grid is only a series of vertical lines, with minimal detail, the digital information is laterally compressed into a narrow segment of the transmission bandwidth.

There is no need to match the virtual grid 80 and the multiplexed image 42 since the virtual grid image 80 and the multiplexed image 42 are always accurately aligned with each other and are always on the same frame 44. As a result, the virtual grid 80 and the multiplexed image 42 are always equally enlarged or reduced. It should be noted that image capture devices 48 may also have means to record and transmit audio. Audio may be transmitted as a sound track 84 on a narrow frequency band to the display means 46.

Means for displaying images, or display means 46, may include a digital monitor or a television screen. The display means 46 utilized with the instant invention can be a flat screen monitor having at least four screens. The flat screen monitor employed herein may be a sandwich of three primary colors screens, screens 64, 66, 68 collectively being a display screen 65, used to display a multiplexed image and a fourth screen 60, being a black and white screen, that is used to display an image of the virtual grid 80.

The virtual grid image 80 is displayed on a virtual viewing lens 63 comprising the fourth screen 60 and a transparent spacer 62. The fourth screen 60 and the display screen 65 are separated an appropriate distance by the transparent spacer 62 made of glass or plastic or other transparent material. The virtual grid is displayed on the fourth screen 60 and must be spaced from the display screen 65 in order for the image to appear to have depth. The fourth screen 60 may be placed in front of or behind the multiplexed image on the display screen 65 to enable viewing a stereoscopic transmitted image in three or four dimensions, but the fourth screen 60 will always be spaced apart from display screen 65 by spacer 62. Standard transmission means are used to transmit the multiplexed image 42 to the display screen 65. The virtual grid image 80 is carried on a separate frequency band 82 being a narrow band like a sound track. The frequency band 82 has the digital image of the virtual grid 80 and is only viewed on the black and white screen 60.

To view 3-D or 4-D images, the virtual grid image 80 which is carried on a separate frequency band 82 must be present to turn “on” or activate the viewing lens 63 to view the virtual grid. The virtual grid in the “on” position, cuts out some light and stops side scatter of the light. To view in 2-D, the virtual grid is absent causing the viewing lens 63 to remain transparent. Thus, the absence of the virtual grid signal turns the viewing lens 63 “off” and the multiplexed image is projected on the display screen 65 of the display means 46 without stereoscopic characteristics. Other 3D systems, require an interposed lenticular lens, which must be constantly adjusted to avoid jumping or skipping when the observer moves or if lenses are not perfectly aligned. Also, all lenticular lenses have aberrations, which also cause distortions.

An alternative embodiment of the present invention is shown in FIG. 3B. where a single camera 360 has a lens 380 and a plurality of image capture devices 480 without lenticular means 50 of FIG. 3A. Here, stereoscopic images are created without the use of any sort of lenticular lens device. The images captured from the plurality of image capture devices 480 are predetermined fractional sub-zone of the target. These images are then transmitted to the device 40 or computer and integrated or multiplexed into a single frame image. The strategic placement of a number of the image capture devices 480 around the target A in effect mimics the principles of a lenticular lens device. Each of the devices 480 act as a lens-less (virtual) lenticular lens to obtain images of the target A at a specified angle or position around the target A.

In the alternative embodiment shown in FIG. 3B compression software is used to multiplex images. Here, the entire angled images taken by capture devices 480 are transmitted to the computer device 40 and multiplexed into the single frame image using compression software to laterally compress the images. An alternative means of multiple image capture, uses multiple capture devices, mounted in straight lines. After the entire image is transmitted to the display 46, decompression is achieved to seamlessly interlace all images. Also, after the entire image is transmitted to the display 46, a re-expansion software package is available to re-expand a single angled view into a full size frame in 2D. In other words, the full view (not a sub zone) is transmitted in the multiplexed image to the display 46. The software can be directed to re-expand that single angled view to full frame, leaving the virtual grid “on” using re-expansion technology, at the display 46. The same software used in the computer can be made to re-expand each angled view to full screen size in the monitor. The resulting image will be 2D and because the grid is in the “on” mode, the image is more detailed to the naked eye because the transmitted light is more focused. Here, the virtual grid remains on and helps increase definition. One example of software that can be used with the present invention is a program entitled 3D Superlacer which is the subject of a UK patent application, filed on ______, with named inventors Ruben Hoppenstein and David Buder.

Similar to the first embodiment, this second embodiment creates the image of the virtual grid using the information obtained, e.g. the number of images captured, at the different angles by capture devices. The presence of the virtual grid triggers the picture of the virtual lens.

Finally, as with the first embodiment, in the second embodiment the multiplexed image and the virtual grid image are always perfectly aligned on the same frame 44 side by side. Thus, the multiplexed image and the virtual grid image are equally enlarged or reduced in size regardless of the size of the monitor used as the display means 46. Thus, the display means 46 may be of any size from cell phone to large displays and still display quality stereoscopic definition of the target image being captured.

The software program (3D Superlacer) can be designed so that it records and combines the entire number of angled views without loss of information and allows for the full screen viewing of any single angular view. Thus, four fully recorded angled views are recorded in that zone and because of lateral compression, all four angled views are placed in that sub-zone. This does not require a wider bandwidth. The resulting multiplexed sub-zone is recorded along with all the others to create the entire multiplexed frame as a seamless panorama, which when the observer moves, has no jumping or other aberrations. In medical, dental or scientific use or studies, the ability to access and view individual frames in full screen with no information being lost is of great value. The software can also provide a wide viewing angle, a panoramic 3D image, and seamless interlacing without the usual flicker or discontinuity as seen with other systems.

The software can also create a virtual grid with the appropriate aperture for that series of angled views. For example, if four angled views are recorded, the program will automatically create a virtual grid obscuring 75% of image, or saying that the aperture (transparent area) is only 25%. This aperture, after the multiplexed image and the virtual grid image is created by the program, is transmitted as an image. The present invention provides a much better and more economical method of producing the virtual grid. By experimentation, it has been determined that the aperture (clear space) should not be less than 22% for optimal effect. The virtual grid should not obscure more than 78% of the light transmitted.

The instant invention accomplishes three-dimensional/four-dimensional imaging to enhance the viewing of any optical image. There is no need to match the virtual grid and the multiplexed image since the virtual grid image and the multiplexed image are always on the same frame 44 and are therefore always equally enlarged and always accurately aligned. The present invention overcomes the time consuming manual alignment necessary in the prior art, which if not done accurately leads to a jumping and poor 3D presentation.

Unlike, the prior art here no micrometer device is necessary, as the virtual grid image and the multiplexed image are always in the correct position for viewing. Furthermore, an aligning micrometer is not needed with display means 46 because the incoming signal is already properly synchronized with the display means 46, as described above. There must be synchronization between the generated Virtual Lens (grid) image and the displayed multiplexed image. This is necessary for alignment and for the display being accommodated on different sized displays. For a digital display, synchronization would also be required which can be accomplished with known digital display synchronization techniques.

Accordingly, special accommodations would not be required for viewing three-dimensional image on screens of different sizes since the stereoscopic images and the virtual grid image are transmitted together in accurate alignment with each other and therefore will be enlarged to the same scale and in alignment on the display means 46. The present invention also obviates the need for constant re-alignment to avoid misaligned images screens on the receiver.

As mentioned above, the display screen 65, spacer 62 and fourth screen 60 can be integrated and combined into a sandwich-like construction, which is suitable for use in flat video display screens, or for electronic advertising displays used for showing 3-D images in a lightbox. In a computer driven 3-D display, different 3-D images can be changed at regular intervals, again using the multiplexed image on one screen and the virtual grid on another. As mentioned above, both images are transmitted together for viewing and should be included on the same frame so that magnification of the 3-D image will be the same from frame-to-frame. This sandwich construction can also be used for viewing 3-D or 4-D fluoroscopic images, computerized tomography (C.T. Scans), magnetic resonance scans, PET Scans, ultrasound images or any other electronic displays.

The stored image can be viewed as four-dimensional if the image is moving and the ten zones/sub-zones are recorded sequentially. It should also be understood that if one frame or photographic recording is being stored, a single three-dimensional image results. However, with known electronic scanning means, each frame could have the ten sub-zones recorded sequentially and because of the sequential recording of each zone and sub-zone, a four-dimensional movie, fluoroscopy, CAT scan, magnetic resonance scan, sonogram, etc., can be produced. The present invention may also be used in conjunction with robotics, security systems, video games, video discs, x-rays, and computer displays. Also, if moving three-dimensional pictures are recorded and displayed in an appropriate time sequence, it is possible to produce three-dimensional/four-dimensional movie displays.

The instant invention may also be used as a real-time image intensifier (fluoroscopy) to obtain three-dimensional x-ray images for catheterization, instant intraoperative localization, and angiography in the medical field. Other uses would be the utilization of three-dimensional x-ray images to view the interior of baggage to enhance airport security and to monitor the interior of motor vehicles at international (or state) borders. For instance, the system can be used and combined with CAD CAM software so that the observer would be able to rotate the 3-D image of a suitcase or other closed container to reveal hidden objects within.

It is an important aspect of the instant invention that it is adaptable for use with existing television receivers. For example, assuming a series of nine cameras, it is possible that camera number 5, in the center of the recording group of cameras, would transmit only a two-dimensional image. The remaining cameras would create a three-dimensional image in the manner described above. These images could be transmitted at alternate sequences electronically, such that a standard television receiver would receive only the two-dimensional image, while virtual lens comprising the fourth screen and the spacer would receive and display a three-dimensional image. Various well known electronic devices are capable of transmitting such alternative information sequences.

Indeed, a multiplexed image can also be created from the combination of images taken from different studies. For example, since CAT scans produce bony landmarks and MRI scans produce excellent soft tissue images, the two can be combined on a single three or four dimensional image, giving accurate coordinates for a physician for stereotactic manipulation or surgery. In addition, physiological studies done on PET scans can also be incorporated. For example, two views from a CAT scan giving bony landmarks, four cuts from an MRI showing soft tissue, and if necessary, two cuts from a PET scan showing metabolic activity, can all be combined on one picture, provided of course that the images are of the same size and the correct angles have been recorded.

In fluorscopy (medical and security), real time observations could be displayed on the GSM Screen by using an X-ray beam that fires sequentially or synchronously from three X-ray beams, as described in U.S. Pat. No. 5,049,987. This would be particularly useful for any catherization, stereotactic surgery or the accurate placement of artificial joints, screws etc. This would minimize the time necessary for the procedure, make operations less hazardous and would be more economical because of the time savings.

A still further use of the instant invention is the possibility that three simultaneous channels could be displayed on the same viewing screen. For example, assuming a transmission of nine sub-zones of information, a viewer present in the center of the screen properly positioned would view sub-zones 4, 5 and 6 of the image, while a viewer to the left of the screen would view sub-zones 1, 2 and 3, and a person to the right of the screen would view sub-zones 7, 8 and 9. If the viewers were properly positioned and the images properly selected for three simultaneous channels, each viewer could respectfully view a different image presentation. It is, of course, understood that headphones or other means would be necessary to separate the audio portion of the three simultaneous displays.

The foregoing merely illustrates the principles of the present invention. Those skilled in the art will be able to devise various modifications, which although not explicitly described or shown herein, embody the principles of the invention and are thus within its spirit and scope.

1. A method for creating a multi-dimensional image comprising:
disposing a plurality of image capture devices around a target, each said plurality of image capture devices being located at different angles with respect to the target;
capturing images of the target using said plurality of image capture devices, wherein each said captured image being a total angled view of the target;
transmitting each said total angled view of the target to a computer; and
combining each said total angled view into a multi-dimensional image using compression technology.

2. The method of claim 1, further comprising:
transmitting the multi-dimensional image in a single frame;
transmitting the multi-dimensional image to a display;
displaying the multi-dimensional image on the display; and
selectively displaying a grid image on the display.

3. (canceled)

4. The method of claim 2, wherein the grid image is transmitted along with the multi-dimensional image in the single frame.

5. The method of claim 2, wherein the grid image is transmitted in accurate alignment with the multi-dimensional image in the single frame.

6. The method of claim 1, wherein the computer includes software for creating the multi-dimensional image and the grid image.

7. A method for creating and viewing a stereoscopic image:
capturing a plurality of images of a target, each said plurality of images being a different predetermined total angled view a target;
combining the plurality of images into a stereoscopic image using a computer; and
displaying the stereoscopic image on the display in conjunction with a grid.

8. A method for creating and viewing a stereoscopic image:
capturing a plurality of images of a target, each said plurality of images being a different predetermined total angled view taken of a target;
combining the plurality of images into a stereoscopic image using a computer;
transmitting the stereoscopic image in a single frame;
transmitting a grid to a display;
displaying the stereoscopic image on the display; and
selectively displaying the grid image on the display,
wherein a stereoscopic image can be viewed based on the selective display of the grid image.

9. The method of claim 8, wherein the plurality of images are captured using at least one image capture device.

10. The method of claim 9, wherein said at least one image capture device is a digital camera.

11. The method of claim 10, wherein the grid image is compressed into a narrow band width.

12. The method of claim 11, wherein the grid image is created based on the number of angle image capture devices that are disposed about the target, or amassed in a straight line before the target.

13. (canceled)

14. The method of claim 13, wherein the virtual grid image is transmitted along with the stereoscopic image in the single frame, said virtual grid image being positioned on an edge of the single frame.

15. The method of claim 14, wherein the grid image is transmitted in accurate alignment with the multiplexed image to the single frame.

16. The method of claim 15, wherein a single angled view of the stereoscopic image can be viewed in 2D when the virtual grid image is not displayed.

17. The method of claim 16, wherein said plurality of images is captured, compressed and multiplexed with no loss of information or resolution.

18. The method of claim 17, wherein each said plurality of images is a two-dimensional image, when one of said plurality of images is viewed by a plurality of viewers on said display, each viewer would see the same said two-dimensional image.

19. The method of claim 18, wherein the stereoscopic image can be viewed in 3D without the need for lenses or other optical devices.

20. The method of claim 19, wherein the virtual grid image and the multiplexed image are transmitted simultaneously on a single frame and can be viewed on any size display screen.

21. The method of claim 2, wherein the target can be viewed in three-dimension when said grid image is displayed on a virtual lens of the display.

22. The method of claim 6, wherein said software creates said grid image and an aperture depending on how many of said captured image devices are employed.

23. The method of claim 2, wherein said grid image is disposed on a side of the frame.

24. The method of claim 1, wherein each total angled view of the target is multiplexed into a single frame.
